(19) United States
(12) Patent Application Publication
(10) Pub. No.: US 2023/0236799 A1
(43) Pub. Date: Jul. 27, 2023

(54) STOCHASTIC ROUNDING FOR NEURAL PROCESSOR CIRCUIT

(71) Applicant: Apple Inc., Cupertino, CA (US)

(72) Inventor: Kenneth W. Waters, San Jose, CA (US)

(21) Appl. No.: 17/582,939

(22) Filed: Jan. 24, 2022

(51) Int. Cl. G06F 7/58; G06F 17/15; G06F 7/499; G06N 3/063

(52) U.S. Cl. CPC G06F 7/584; G06F 17/15; G06F 7/49947; G06N 3/063; G06F 2207/581

(57) ABSTRACT

Embodiments relate to a neural processor circuit that includes a neural engine and a post-processing circuit. The neural engine performs a computational task related to a neural network to generate a processed value. The post-processing circuit includes a random bit generator, an adder circuit and a rounding circuit. The random bit generator generates a random string of bits. The adder circuit adds the random string of bits to a version of the processed value to generate an added value. The rounding circuit truncates the added value to generate an output value of the computational task. The random bit generator may include a linear-feedback shift register (LFSR) that generates random numbers based on a seed. The seed may be derived from a master seed that is specific to a task of the neural network.

### BACKGROUND

### 1. Field of the Disclosure

The present disclosure relates to a circuit for performing operations related to neural networks, and more specifically to performing stochastic rounding for processed values of a neural engine.

### 2. Description of the Related Arts

An artificial neural network (ANN) is a computing system or model that uses a collection of connected nodes to process input data. The ANN is typically organized into layers where different layers perform different types of transformation on their input. Extensions or variants of ANN such as convolution neural network (CNN), recurrent neural networks (RNN) and deep belief networks (DBN) have come to receive much attention. These computing systems or models often involve extensive computing operations including multiplication and accumulation. For example, CNN is a class of machine learning technique that primarily uses convolution between input data and kernel data, which can be decomposed into multiplication and accumulation operations.

Depending on the types of input data and operations to be performed, these machine learning systems or models can be configured differently. Such varying configuration would include, for example, pre-processing operations, the number of channels in input data, kernel data to be used, non-linear function to be applied to convolution result, and applying of various post-processing operations. Using a central processing unit (CPU) and its main memory to instantiate and execute machine learning systems or models of various configuration is relatively easy because such systems or models can be instantiated with mere updates to code. However, relying solely on the CPU for various operations of these machine learning systems or models would consume significant bandwidth of a central processing unit (CPU) as well as increase the overall power consumption.

The performance of the neural processor may impact the accuracy and speed in training and performance inference of neural networks trained by the processor. Various processes and computations involved could cause bias and other issues such as overfitting in a neural network. In some cases, intentionally introducing some unbiased noise to a neural network may enhance the performance of the network during training and inference.

### SUMMARY

Embodiments relate to a neural processor circuit that includes a neural engine and a post-processing circuit. The neural engine performs a convolutional operation related to a neural network to generate a processed value. The post-processing circuit is coupled to the neural engine. The post-processing circuit rounds the processed value stochastically. The post-processing circuit includes a random bit generator, an adder circuit, and a rounding circuit. The random bit generator generates a random string of bits. The adder circuit adds the random string of bits to a version of the processed value to generate an added value. The rounding circuit truncates the added value to generate an output value of the convolutional operation.

### BRIEF DESCRIPTION OF THE DRAWINGS

FIG. 1 is a high-level diagram of an electronic device, according to one embodiment

FIG. 2 is a block diagram illustrating components in the electronic device, according to one embodiment.

FIG. 3 is a block diagram illustrating a neural processor circuit, according to one embodiment.

FIG. 4 is a block diagram of a neural engine in the neural processor circuit, according to one embodiment.

FIG. 5 is a block diagram of a planar engine in the neural processor circuit, according to one embodiment.

FIG. 6A illustrates a standard rounding mode that uses a round half up rule, according to one embodiment.

FIG. 6B illustrates a stochastic rounding mode for rounding an integer, according to one embodiment.

FIG. 6C illustrates a stochastic rounding mode for rounding a floating-point number, according to one embodiment.

FIG. 7 is a block diagram illustrating an example post-processing circuit, according to one embodiment.

FIG. 8 is an example circuit diagram of a random bit generator circuit that includes multiple linear feedback shift registers, according to one embodiment.

FIG. 9 is a flowchart illustrating an example process for performing neural processing operations with stochastic rounding, according to one embodiment.

The figures depict, and the detailed description describes various non-limiting embodiments for purposes of illustration only.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, the described embodiments may be practiced without these specific details. In other instances, well-known methods, procedures, components, circuits, and networks have not been described in detail so as not to unnecessarily obscure aspects of the embodiments.

Embodiments of the present disclosure relate to a neural processor circuit that may round stochastically outputs of computational tasks in a machine learning model. A neural process circuit may include a master seed generator and multiple random bit generators that generate random strings of bits in parallel based on the master seed. The stochastic rounding intentionally adds noise to the machine learning model to enhance the performance of the model during training and inference. The use of a master seed generator generates well-randomized numbers in a fast manner to round various results of the neural processor circuit in parallel.

### Example Electronic Device

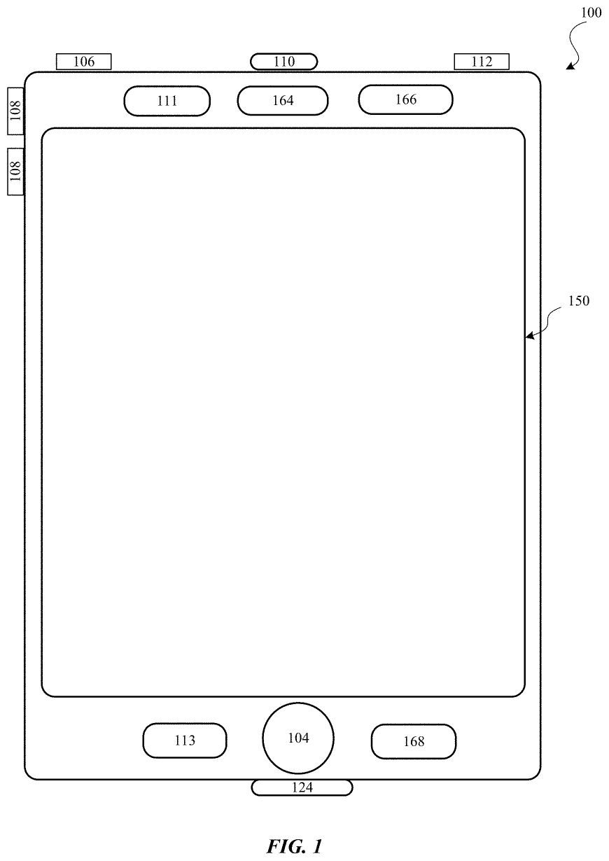

Embodiments of electronic devices, user interfaces for such devices, and associated processes for using such devices are described. In some embodiments, the device is a portable communications device, such as a mobile telephone, that also contains other functions, such as personal digital assistant (PDA) and/or music player functions. Exemplary embodiments of portable multifunction devices include, without limitation, the iPhone®, iPod Touch®, Apple Watch®, and iPad® devices from Apple Inc. of Cupertino, Calif. Other portable electronic devices, such as wearables, laptops or tablet computers, are optionally used. In some embodiments, the device is not a portable communication device, but is a desktop computer or other computing device that is not designed for portable use. In some embodiments, the disclosed electronic device may include a touch-sensitive surface (e.g., a touch screen display and/or a touchpad). An example electronic device described below in conjunction with Figure (FIG. 1 (e.g., device 100) may include a touch-sensitive surface for receiving user input. The electronic device may also include one or more other physical user-interface devices, such as a physical keyboard, a mouse and/or a joystick.

FIG. 1 is a high-level diagram of an electronic device 100, according to one embodiment. Device 100 may include one or more physical buttons, such as a “home” or menu button 104. Menu button 104 is, for example, used to navigate to any application in a set of applications that are executed on device 100. In some embodiments, menu button 104 includes a fingerprint sensor that identifies a fingerprint on menu button 104. The fingerprint sensor may be used to determine whether a finger on menu button 104 has a fingerprint that matches a fingerprint stored for unlocking device 100. Alternatively, in some embodiments, menu button 104 is implemented as a soft key in a graphical user interface (GUI) displayed on a touch screen.

In some embodiments, device 100 includes touch screen 150, menu button 104, push button 106 for powering the device on/off and locking the device, volume adjustment buttons 108, Subscriber Identity Module (SIM) card slot 110, headset jack 112, and docking/charging external port 124. Push button 106 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 includes various components including, but not limited to, a memory (which may include one or more computer readable storage mediums), a memory controller, one or more central processing units (CPUs), a peripherals interface, an RF circuitry, an audio circuitry, speaker 111, microphone 113, input/output (I/O) subsystem, and other input or control devices. Device 100 may include one or more image sensors 164, one or more proximity sensors 166, and one or more accelerometers 168. Device 100 may include more than one type of image sensors 164. Each type may include more than one image sensor 164. For example, one type of image sensors 164 may be cameras and another type of image sensors 164 may be infrared sensors for facial recognition that is performed by one or more machine learning models stored in device 100. Device 100 may include components not shown in FIG. 1 such as an ambient light sensor, a dot projector and a flood illuminator that is to support facial recognition.

In some embodiments, device 100 may operate in different orientations. For example, device 100 detects the orientation that a user is holding device 100 (e.g., upright or sideways) and automatically rotates the contents displayed in touch screen 150. The software application for image sensors 164 such as the cameras may also rotate to allow users to capture images in a portrait mode and in a landscape mode. In some cases, the camera software application may also operate in rotations of 180 degrees and 270 degrees. Images generated by image sensors 164 may be in different rotations.

Device 100 is only one example of an electronic device, and device 100 may have more or fewer components than listed above, some of which may be combined into a component or have a different configuration or arrangement. The various components of device 100 listed above are embodied in hardware, software, firmware or a combination thereof, including one or more signal processing and/or application-specific integrated circuits (ASICs).

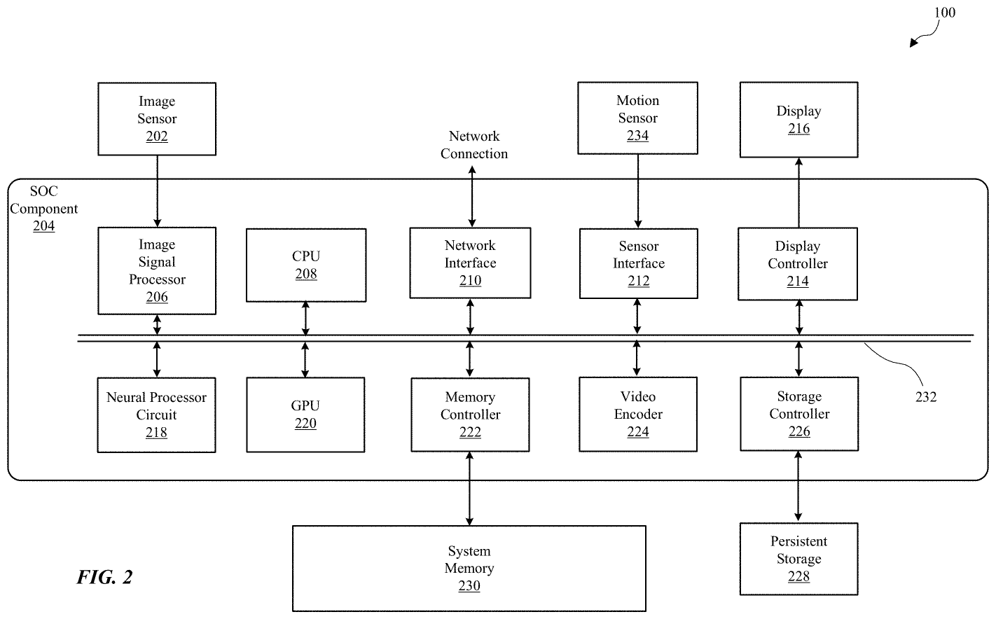

FIG. 2 is a block diagram illustrating components in device 100, according to one embodiment. Device 100 may perform various operations including implementing one or more machine learning models. For this and other purposes, device 100 may include, among other components, image sensors 202, a system-on-a chip (SOC) component 204, a system memory 230, a persistent storage (e.g., flash memory) 228, a motion sensor 234, and a display 216. The components as illustrated in FIG. 2 are merely illustrative. For example, device 100 may include other components (such as speaker or microphone) that are not illustrated in FIG. 2. Further, some components (such as motion sensor 234) may be omitted from device 100.

An image sensor 202 is a component for capturing image data and may be embodied, for example, as a complementary metal-oxide-semiconductor (CMOS) active-pixel sensor) a camera, video camera, or other devices. Image sensor 202 generates raw image data that is sent to SOC component 204 for further processing. In some embodiments, the image data processed by SOC component 204 is displayed on display 216, stored in system memory 230, persistent storage 228 or sent to a remote computing device via network connection. The raw image data generated by image sensor 202 may be in a Bayer color kernel array (CFA) pattern. Objects generated in the raw image data may be in different orientations. For example, a user may take a first image in a portrait mode, turn device 100 sideway, and take a second image in a landscape mode. The objects in the second image may appear to be turned 90 degrees compared to the first image.

Motion sensor 234 is a component or a set of components for sensing motion of device 100. Motion sensor 234 may generate sensor signals indicative of orientation and/or acceleration of device 100. The sensor signals are sent to SOC component 204 for various operations such as turning on device 100 or rotating images displayed on display 216.

Display 216 is a component for displaying images as generated by SOC component 204. Display 216 may include, for example, liquid crystal display (LCD) device or an organic light-emitting diode (OLED) device. Based on data received from SOC component 204, display 116 may display various images, such as menus, selected operating parameters, images captured by image sensor 202 and processed by SOC component 204, and/or other information received from a user interface of device 100 (not shown).

System memory 230 is a component for storing instructions for execution by SOC component 204 and for storing data processed by SOC component 204. System memory 230 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM) or a combination thereof.

Persistent storage 228 is a component for storing data in a non-volatile manner. Persistent storage 228 retains data even when power is not available. Persistent storage 228 may be embodied as read-only memory (ROM), flash memory or other non-volatile random access memory devices. Persistent storage 228 stores an operating system of device 100 and various software applications. Persistent storage 228 may also store one or more machine learning models, such as regression models, random forest models, support vector machines (SVMs) such as kernel SVMs, and artificial neural networks (ANNs) such as convolutional network networks (CNNs), recurrent network networks (RNNs), autoencoders, and long short term memory (LSTM). A machine learning model may be an independent model that works with the neural processor circuit 218 and various software applications or sensors of device 100. A machine learning model may also be part of a software application. The machine learning models may perform various tasks such as facial recognition, image classification, object, concept, and information classification, speech recognition, machine translation, voice recognition, voice command recognition, text recognition, text and context analysis, other natural language processing, predictions, and recommendations.

Various machine learning models stored in device 100 may be fully trained, untrained, or partially trained to allow device 100 to reinforce or continue to train the machine learning models as device 100 is used. Operations of the machine learning models include various computation used in training the models and determining results in runtime using the models. For example, in one case, device 100 captures facial images of the user and uses the images to continue to improve a machine learning model that is used to lock or unlock the device 100.

SOC component 204 is embodied as one or more integrated circuit (IC) chip and performs various data processing processes. SOC component 204 may include, among other subcomponents, image signal processor (ISP) 206, a central processor unit (CPU) 208, a network interface 210, sensor interface 212, display controller 214, neural processor circuit 218, graphics processor (GPU) 220, memory controller 222, video encoder 224, storage controller 226, and bus 232 connecting these subcomponents. SOC component 204 may include more or fewer subcomponents than those shown in FIG. 2.

ISP 206 is a circuit that performs various stages of an image processing pipeline. In some embodiments, ISP 206 may receive raw image data from image sensor 202, and process the raw image data into a form that is usable by other subcomponents of SOC component 204 or components of device 100. ISP 206 may perform various image-manipulation operations such as image translation operations, horizontal and vertical scaling, color space conversion and/or image stabilization transformations.

CPU 208 may be embodied using any suitable instruction set architecture, and may be configured to execute instructions defined in that instruction set architecture. CPU 208 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 2, SOC component 204 may include multiple CPUs. In multiprocessor systems, each of the CPUs may commonly, but not necessarily, implement the same ISA.

Graphics processing unit (GPU) 220 is graphics processing circuitry for performing graphical data. For example, GPU 220 may render objects to be displayed into a frame buffer (e.g., one that includes pixel data for an entire frame). GPU 220 may include one or more graphics processors that may execute graphics software to perform a part or all of the graphics operation, or hardware acceleration of certain graphics operations.

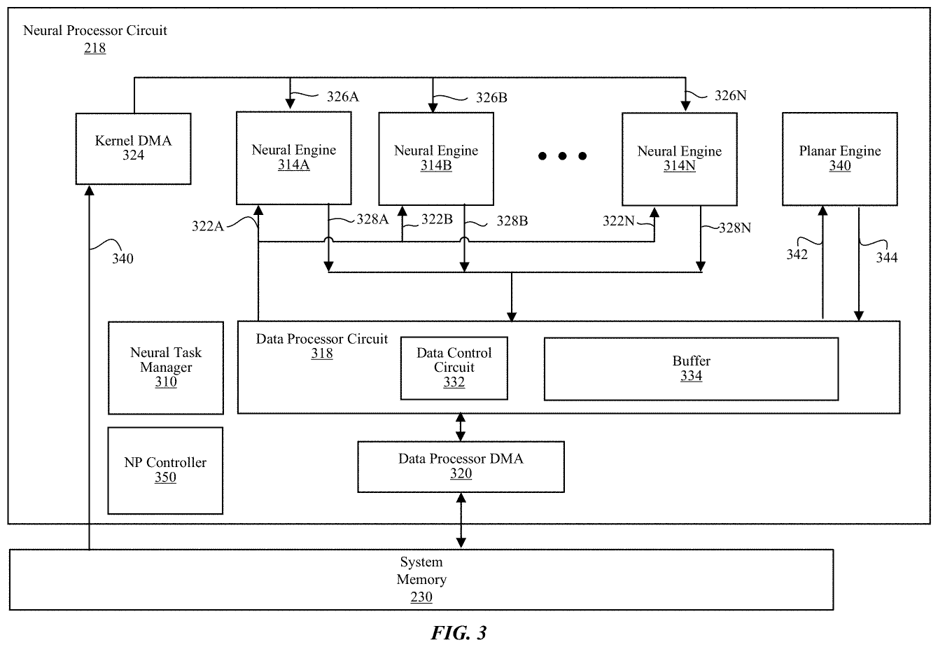

Neural processor circuit 218 is a circuit that performs various machine learning operations based on computation including multiplication, addition, and accumulation. Such computation may be arranged to perform, for example, various types of tensor multiplications such as tensor product and convolution of input data and kernel data. Neural processor circuit 218 is a configurable circuit that performs these operations in a fast and power-efficient manner while relieving CPU 208 of resource-intensive operations associated with neural network operations. Neural processor circuit 218 may receive the input data from sensor interface 212, the image signal processor 206, persistent storage 228, system memory 230 or other sources such as network interface 210 or GPU 220. The output of neural processor circuit 218 may be provided to various components of device 100 such as image signal processor 206, system memory 230 or CPU 208 for various operations. The structure and operation of neural processor circuit 218 are described below in detail with reference to FIG. 3.

Network interface 210 is a subcomponent that enables data to be exchanged between devices 100 and other devices via one or more networks (e.g., carrier or agent devices). For example, video or other image data may be received from other devices via network interface 210 and be stored in system memory 230 for subsequent processing (e.g., via a back-end interface to image signal processor 206) and display. The networks may include, but are not limited to, Local Area Networks (LANs) (e.g., an Ethernet or corporate network) and Wide Area Networks (WANs). The image data received via network interface 210 may undergo image processing processes by ISP 206.

Sensor interface 212 is circuitry for interfacing with motion sensor 234. Sensor interface 212 receives sensor information from motion sensor 234 and processes the sensor information to determine the orientation or movement of device 100.

Display controller 214 is circuitry for sending image data to be displayed on display 216. Display controller 214 receives the image data from ISP 206, CPU 208, graphic processor or system memory 230 and processes the image data into a format suitable for display on display 216.

Memory controller 222 is circuitry for communicating with system memory 230. Memory controller 222 may read data from system memory 230 for processing by ISP 206, CPU 208, GPU 220 or other subcomponents of SOC component 204. Memory controller 222 may also write data to system memory 230 received from various subcomponents of SOC component 204.

Video encoder 224 is hardware, software, firmware or a combination thereof for encoding video data into a format suitable for storing in persistent storage 128 or for passing the data to network interface 210 for transmission over a network to another device.

In some embodiments, one or more subcomponents of SOC component 204 or some functionality of these subcomponents may be performed by software components executed on neural processor circuit 218, ISP 206, CPU 208 or GPU 220. Such software components may be stored in system memory 230, persistent storage 228 or another device communicating with device 100 via network interface 210.

### Example Neural Processor Circuit

Neural processor circuit 218 is a programmable circuit that performs machine learning operations on the input data of neural processor circuit 218. Machine learning operations may include different computations for training of a machine learning model and for performing inference or prediction based on the trained machine learning model. Performing inference or prediction may sometimes be referred to as the runtime of the machine learning model.

Taking an example of a CNN as the machine learning model, training of the CNN may include forward propagation and backpropagation. A neural network may include an input layer, an output layer, and one or more intermediate layers that may be referred to as hidden layers. Each layer may include one or more nodes, which may be fully or partially connected to other nodes in adjacent layers. In forward propagation, the neural network performs computation in the forward direction based on outputs of a preceding layer. The operation of a node may be defined by one or more functions. The functions that define the operation of a node may include various computation operation such as convolution of data with one or more kernels, pooling of layers, tensor multiplication, etc. The functions may also include an activation function that adjusts the weight of the output of the node. Nodes in different layers may be associated with different functions. For example, a CNN may include one or more convolutional layers that are mixed with pooling layers and are followed by one or more fully connected layers.

Each of the functions, including kernels, in a machine learning model may be associated with different coefficients that are adjustable during training. In addition, some of the nodes in a neural network each may also be associated with an activation function that decides the weight of the output of the node in a forward propagation. Common activation functions may include step functions, linear functions, sigmoid functions, hyperbolic tangent functions (tan h), and rectified linear unit functions (ReLU). After a batch of data of training samples passes through a neural network in the forward propagation, the results may be compared to the training labels of the training samples to compute the network's loss function, which represents the performance of the network. In turn, the neural network performs backpropagation by using coordinate descent such as stochastic coordinate descent (SGD) to adjust the coefficients in various functions to improve the value of the loss function. The values in various kernels, node weights, activation functions, and other weights in a machine learning model may be referred to as coefficient data.

In training, device 100 may use neural processor circuit 218 to perform all or some of the operations in the forward propagation and backpropagation. Multiple rounds of forward propagation and backpropagation may be performed by neural processor circuit 218, solely or in coordination with other processors such as CPU 208, GPU 220, and ISP 206. Training may be completed when the loss function no longer improves (e.g., the machine learning model has converged) or after a predetermined number of rounds for a particular set of training samples. As device 100 is used, device 100 may continue to collect additional training samples for the neural network.

For prediction or inference, device 100 may receive one or more input samples. Neural processor circuit 218 may take the input samples to perform forward propagation to determine one or more results. The input samples may be images, speeches, text files, sensor data, or other data.

Data and functions (e.g., input data, kernels, functions, layers outputs, gradient data) in machine learning may be saved and represented by one or more tensors. Common operations related to training and runtime of a machine learning model may include tensor product, tensor transpose, tensor elementwise operation, convolution, application of an activation function, automatic differentiation to determine gradient, statistics and aggregation of values in tensors (e.g., average, variance, standard deviation), tensor rank and size manipulation, etc.

While the training and runtime of a neural network is discussed as an example, the neural processor circuit 218 may also be used for the operations of other types of machine learning models, such as a kernel SVM.

Referring to FIG. 3, an example neural processor circuit 218 may include, among other components, neural task manager 310, a plurality of neural engines 314A through 314N (hereinafter collectively referred as “neural engines 314” and individually also referred to as “neural engine 314”), kernel direct memory access (DMA) 324, data processor circuit 318, data processor DMA 320, planar engine 340, and neural processor (NP) controller 350. Neural processor circuit 218 may include fewer components than what are illustrated in FIG. 3 or include additional components not illustrated in FIG. 3.

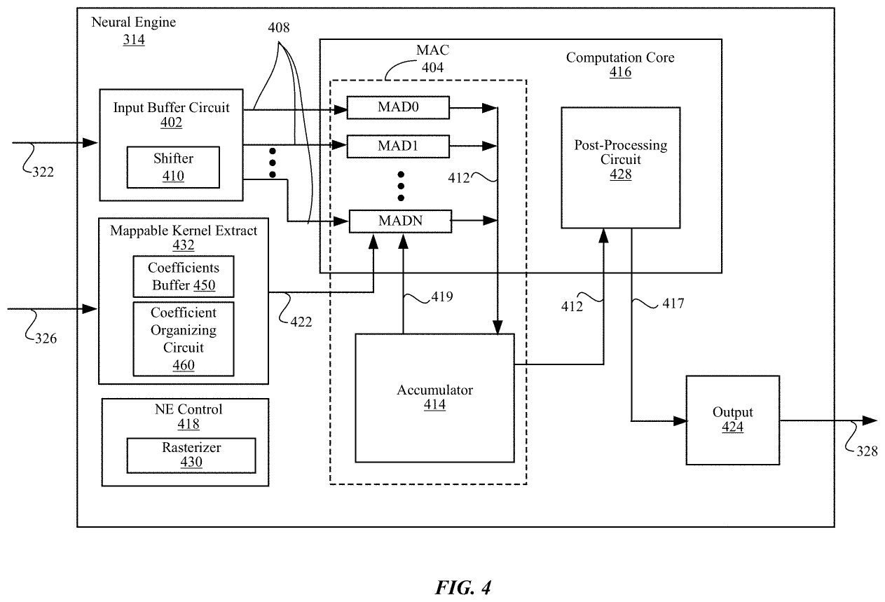

Each of neural engines 314 performs computing operations for machine learning in parallel. Depending on the load of operation, the entire set of neural engines 314 may be operating or only a subset of the neural engines 314 may be operating while the remaining neural engines 314 are placed in a power-saving mode to conserve power. Each of neural engines 314 includes components for storing one or more kernels, for performing multiply-accumulate operations, and for post-processing to generate an output data 328, as described below in detail with reference to FIG. 4. Neural engines 314 may specialize in performing computation heavy operations such as convolution operations and tensor product operations. Convolution operations may include different kinds of convolutions, such as cross-channel convolutions (a convolution that accumulates values from different channels), channel-wise convolutions, and transposed convolutions.

Planar engine 340 may specialize in performing simpler computing operations whose speed may primarily depend on the input and output (I/O) speed of the data transmission instead of the computation speed within planar engine 340. These computing operations may be referred to as I/O bound computations and are also referred to as “non-convolution operations” herein. In contrast, neural engines 314 may focus on complex computation such as convolution operations whose speed may primarily depend on the computation speed within each neural engine 314. For example, planar engine 340 is efficient at performing operations within a single channel while neural engines 314 are efficient at performing operations across multiple channels that may involve heavy accumulation of data. The use of neural engine 314 to compute I/O bound computations may not be efficient in terms of both speed and power consumption. In one embodiment, input data may be a tensor whose rank is larger than three (e.g., having three or more dimensions). A set of dimensions (two or more) in the tensor may be referred to as a plane while another dimension may be referred to as a channel. Neural engines 314 may convolve data of a plane in the tensor with a kernel and accumulate results of the convolution of different planes across different channels. On the other hand, planar engine 340 may specialize in operations within the plane.

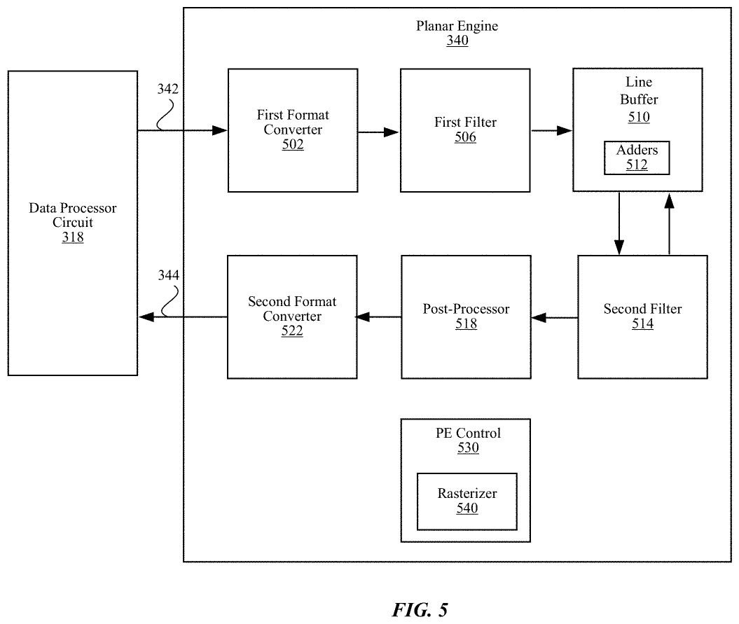

The circuitry of planar engine 340 may be programmed for operation in one of multiple modes, including a pooling mode, an elementwise mode, and a reduction mode. In the pooling mode, planar engine 340 reduce a spatial size of input data. In the elementwise mode, planar engine 340 generates an output that is derived from elementwise operations of one or more inputs. In the reduction mode, planar engine 340 reduces the rank of a tensor. For example, a rank 5 tensor may be reduced to a rank 2 tensor, or a rank 3 tensor may be reduced to a rank 0 tensor (e.g., a scalar). The operations of planar engine 340 will be discussed in further detail below with reference to FIG. 5.

Neural task manager 310 manages the overall operation of neural processor circuit 218. Neural task manager 310 may receive a task list from a compiler executed by CPU 208, store tasks in its task queues, choose a task to perform, and send task commands to other components of the neural processor circuit 218 for performing the chosen task. Data may be associated with a task command that indicates the types of operations to be performed on the data. Data of the neural processor circuit 218 includes input data that is transmitted from another source such as system memory 230, and data generated by the neural processor circuit 218 in a previous operation cycle. Each dataset may be associated with a task command that specifies the type of operations to be performed on the data. Neural task manager 310 may also perform switching of tasks on detection of events such as receiving instructions from CPU 208. In one or more embodiments, neural task manager 310 sends rasterizer information to the components of neural processor circuit 218 to enable each of the components to track, retrieve or process appropriate segments of the input data and kernel data. For example, neural task manager 310 may include registers that stores the information regarding the size and rank of a dataset for processing by the neural processor circuit 218. Although neural task manager 310 is illustrated in FIG. 3 as part of neural processor circuit 218, neural task manager 310 may be a component outside the neural processor circuit 218.

Kernel DMA 324 is a read circuit that fetches kernel data from a source (e.g., system memory 230) and sends kernel data 326A through 326N to each of the neural engines 314. Kernel data represents information from which kernel elements can be extracted. In one embodiment, the kernel data may be in a compressed format which is decompressed at each of neural engines 314. Although kernel data provided to each of neural engines 314 may be the same in some instances, the kernel data provided to each of neural engines 314 is different in most instances. In one embodiment, the direct memory access nature of kernel DMA 324 may allow kernel DMA 324 to fetch and write data directly from the source without the involvement of CPU 208.

Data processor circuit 318 manages data traffic and task performance of neural processor circuit 218. Data processor circuit 318 may include a data control circuit 332 and a buffer 334. Buffer 334 is temporary storage for storing data associated with operations of neural processor circuit 218, such as input data that is transmitted from system memory 230 (e.g., data from a machine learning model) and other data that is generated within neural processor circuit 218. The input data may be transmitted from system memory 230. The data stored in data processor circuit 318 may include different subsets that are sent to various downstream components, such as neural engines 314 and planar engine 340.

In one embodiment, buffer 334 is embodied as a non-transitory memory that can be accessed by neural engines 314 and planar engine 340. Buffer 334 may store input data 322A through 322N (also referred to as “neural input data” herein) for feeding to corresponding neural engines 314A through 314N and input data 342 (also referred to as “planar input data” herein) for feeding to planar engine 340, as well as output data 328A through 328N from each of neural engines 314A through 314N (also referred to as “neural output data” herein) and output data 344 from planar engine 340 (also referred to as “planar output data” herein) for feeding back into one or more neural engines 314 or planar engine 340, or sending to a target circuit (e.g., system memory 230). Buffer 334 may also store input data 342 and output data 344 of planar engine 340 and allow the exchange of data between neural engine 314 and planar engine 340. For example, one or more output data 328A through 328N of neural engines 314 are used as planar input data 342 to planar engine 340. Likewise, planar output data 344 of planar engine 340 may be used as the input data 322A through 322N of neural engines 314. The inputs of neural engines 314 or planar engine 340 may be any data stored in buffer 334. For example, in various operating cycles, the source datasets from which one of the engines fetches as inputs may be different. The input of an engine may be an output of the same engine in previous cycles, outputs of different engines, or any other suitable source datasets stored in buffer 334. Also, a dataset in buffer 334 may be divided and sent to different engines for different operations in the next operating cycle. Two datasets in buffer 334 may also be joined for the next operation.

Data control circuit 332 of data processor circuit 318 may control the exchange of data between neural engines 314 and planar engine 340. The operations of data processor circuit 318 and other components of neural processor circuit 218 are coordinated so that the input data and intermediate data stored in data processor circuit 318 may be reused across multiple operations at neural engines 314 and planar engine 340, thereby reducing data transfer to and from system memory 230. Data control circuit 332 may perform one or more of the following operations: (i) monitor the size and rank of data (e.g. data may be one or more tensors) that are being processed by neural engines 314 and planar engine 340, (ii) determine which subsets of data are transmitted to neural engines 314 or to planar engine 340 based on the task commands associated with different subsets of data, (iii) determine the manner in which data is transmitted to neural engines 314 and planar engine 340 (e.g., the data processor circuit 318 may operate in a broadcast mode where the same data is fed to multiple input channels of neural engines 314 so that multiple or all neural engines 314 receive the same data or in a unicast mode where different neural engines 314 receives different data), and (iv) transmit a configuration command to the planar engine 340 to direct planar engine 340 to program itself for operating in one of multiple operation modes.

The data of neural processor circuit 218 stored in buffer 334 may be part of, among others, image data, histogram of oriented gradients (HOG) data, audio data, metadata, output data 328 of a previous cycle of a neural engine 314, and other processed data received from other components of the SOC component 204.

Data processor DMA 320 includes a read circuit that receives a segment of the input data from a source (e.g., system memory 230) for storing in buffer 334, and a write circuit that forwards data from buffer 334 to a target component (e.g., system memory). In one embodiment, the direct memory access nature of data processor DMA 320 may allow data processor DMA 320 to fetch and write data directly from a source (e.g., system memory 230) without the involvement of CPU 208. Buffer 334 may be a direct memory access buffer that stores data of a machine learning model of device 100 without involvement of CPU 208.

Neural Processor (NP) controller 350 is a control circuit that performs various operations to control the overall operation of neural processor circuit 218. NP controller 350 may interface with CPU 208, program components of neural processor circuit 218 by setting register in the components and perform housekeeping operations. NP controller 350 may also initialize components in neural processor circuit 218 when neural processor circuit 218 is turned on.

### Example Neural Engine Architecture

FIG. 4 is a block diagram of neural engine 314, according to one embodiment. Neural engine 314 is a circuit that performs various computational operations to facilitate machine learning such as convolution, tensor product, and other operations may involve heavy computation. For this purpose, neural engine 314 receives input data 322, performs multiply-accumulate operations (e.g., convolution operations) on input data 322 based on stored kernel data, performs further post-processing operations on the result of the multiply-accumulate operations, and generates output data 328. Input data 322 and/or output data 328 of neural engine 314 may be of a single channel or span across multiple channels.

Neural engine 314 may include, among other components, input buffer circuit 402, computation core 416, neural engine (NE) control 418, mappable kernel extract circuit 432, accumulator 414 and output circuit 424. Neural engine 314 may include fewer components than what is illustrated in FIG. 4 or include further components not illustrated in FIG. 4.

Input buffer circuit 402 is a circuit that stores a subset of the data of neural processor circuit 218 as the subset of data is received from a source. The source may be data processor circuit 318, planar engine 340, or another suitable component. Input buffer circuit 402 sends an appropriate segment 408 of data for a current task or process loop to computation core 416 for processing. Input buffer circuit 402 may include a shifter 410 that shifts read locations of input buffer circuit 402 to change segment 408 of data sent to computation core 416. By changing segments of input data provided to computation core 416 via shifting, neural engine 314 can perform multiply-accumulate for different segments of input data based on a fewer number of read operations. In one or more embodiments, the data of neural processor circuit 218 includes data of difference convolution groups and/or input channels.

Mappable kernel extract circuit 432 is a circuit that receives kernel data 326 and other coefficient data from kernel DMA 324 and extracts kernel coefficients 422. For convenience, data 326 is referred to as kernel data 326, but data 326 may also other coefficient data and the data may be processed in a manner similar to the kernel data by neural engine 314. In one embodiment, mappable kernel extract circuit 432 references a lookup table (LUT) and uses a mask to reconstruct a kernel from compressed kernel data 326 based on the LUT. The mask indicates locations in the reconstructed kernel to be padded with zero and remaining locations to be filled with numbers. Kernel coefficients 422 of the reconstructed kernel are sent to computation core 416 to populate register in multiply-add (MAD) circuits of computation core 416. In other embodiments, mappable kernel extract circuit 432 receives kernel data in an uncompressed format and the kernel coefficients are determined without referencing a LUT or using a mask.

The kernel data and other coefficient data, whether reconstructed from compressed data or fetched directly from kernel DMA 324, may be saved in coefficients buffer 450, which is a circuit that has different memory addresses for storing various values. The coefficient data may be a set of values that are stored in different memory addresses. For example, a 3×3 kernel has 9 different values of coefficient data that may be stored in different memory addresses of the coefficients buffer 450. Other types of coefficient data may include other sets of values, such as weights, activation coefficients, neuron coefficients of a machine learning model. A set of coefficient data that is read in a particular order may be provided to the MAC 404 as coefficients 422 for computation.

The same set of coefficient data may be generated as different mappings. The mappings may serve as different input coefficients 422 to be separately provided to the MAC 404 for different operating cycles. A coefficient organizing circuit 460 generates different mappings of the coefficient data by any suitable ways, such as by changing the read orders of memory addresses of the coefficients buffer 450 for a downstream computation circuit (e.g., MAC 404) to fetch the values saved in coefficients buffer 450 based on the different read orders. For example, in one case, a 3×3 kernel may be read row by row, which represents a first mapping of the kernel. In another case, the same kernel may be read column by column, which represents a second mapping of the kernel. The coefficient organizing circuit 460 may receive multiple control signals. Each control signal may correspond to a particular mapping. Based on the control signals, the coefficient organizing circuit 460 generates various read orders of the memory addresses. The same set of coefficient data may be used to generate different mappings for the computation of the MAC 404 with segments 408 of the input data. The generation of multiple mappings from a set of coefficient data reduces the size of the machine learning model because a set of values may be used to represent different kernels or other weight sets. This also speeds up the computation of the machine learning model in training and in runtime.

Computation core 416 is a programmable circuit that performs computation operations. For this purpose, computation core 416 may include MAD circuits MAD0 through MADN and a post-processing circuit 428. Each of MAD circuits MAD0 through MADN may store an input value in the segment 408 of the input data and a corresponding kernel coefficient in kernel coefficients 422. The input value and the corresponding kernel coefficient are multiplied in each of MAD circuits to generate a processed value 412.

Accumulator 414 is a memory circuit that receives and stores processed values 412 from MAD circuits. The processed values stored in accumulator 414 may be sent back as feedback information 419 for further multiply and add operations at MAD circuits or sent to post-processing circuit 428 for post-processing. Accumulator 414 in combination with MAD circuits form a multiply-accumulator (MAC) 404. In one or more embodiments, accumulator 414 may have subunits where each subunit sends data to different components of neural engine 314. For example, during a processing cycle, data stored in a first subunit of accumulator 414 is sent to the MAC circuit while data stored in a second subunit of accumulator 414 is sent to post-processing circuit 428.

Post-processing circuit 428 is a circuit that performs further processing of values 412 received from accumulator 414. Post-processing circuit 428 may perform operations including, but not limited to, applying linear functions (e.g., Rectified Linear Unit (ReLU)), normalized cross-correlation (NCC), merging the results of performing neural operations on 8-bit data into 16-bit data, local response normalization (LRN), and rounding. The result of such operations is output from post-processing circuit 428 as processed values 417 to output circuit 424. In some embodiments, the processing at the post-processing circuit 428 is bypassed. For example, the data in accumulator 414 may be sent directly to output circuit 424 for access by other components of neural processor circuit 218.

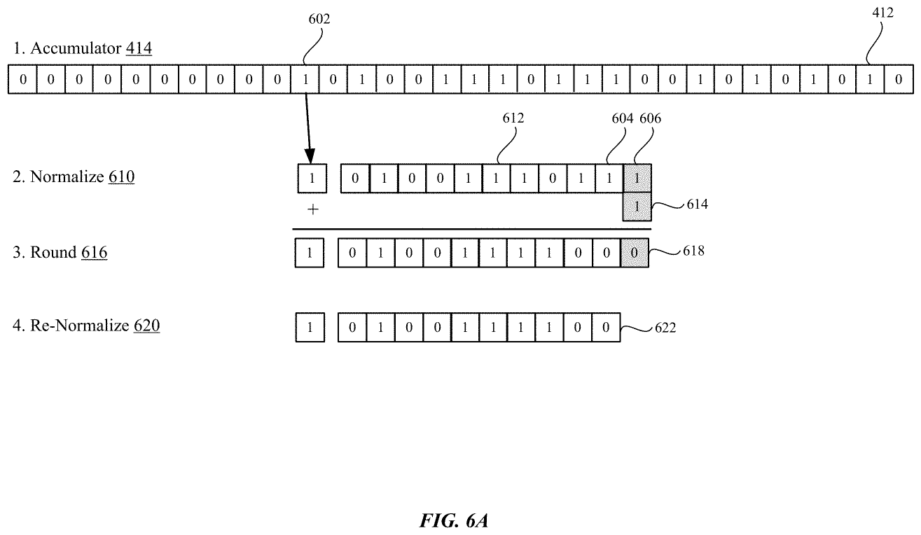

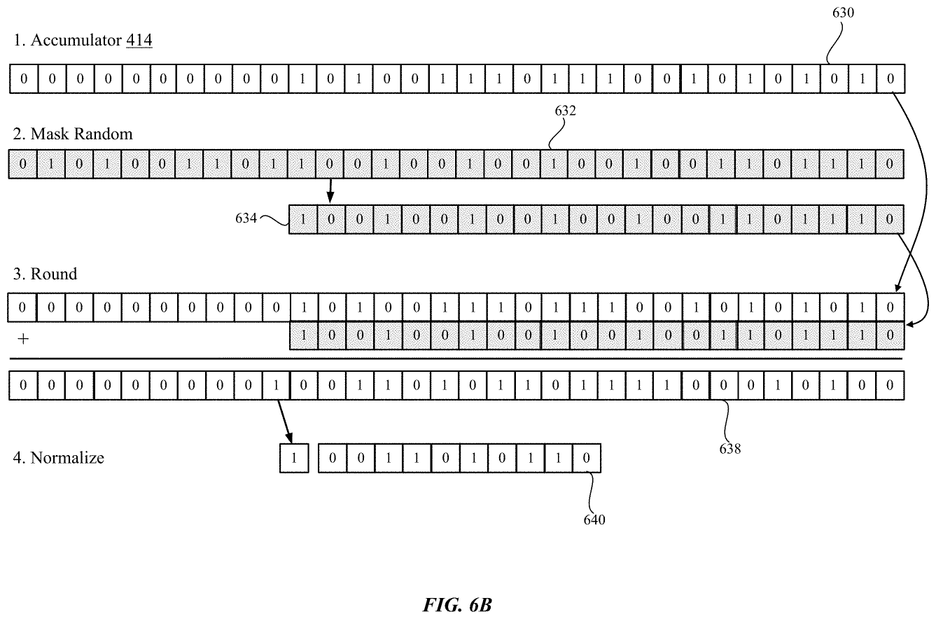

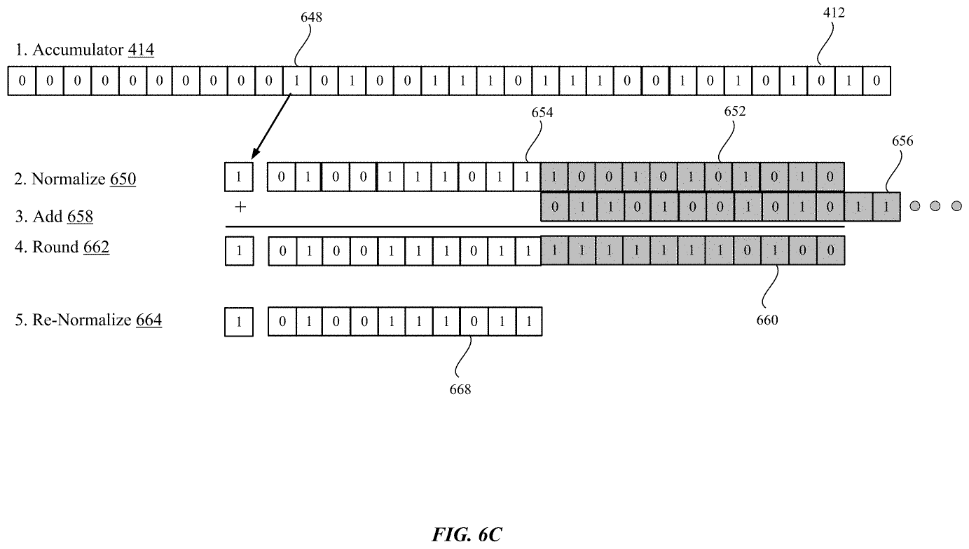

In some embodiments, post-processing circuit 428 may operate in different modes of rounding that reduce the number of significant figures in the processed value 412 in generating the output data 328. The modes of rounding may include standard rounding, stochastic rounding of an integer, and stochastic rounding of a floating-point number. In standard rounding, the typical round half up rule is used to round an integer or floating-point number where values at the rounding location that exceeds the halfway value are rounded up and values that are below the halfway are rounded down. In a stochastic rounding mode, a random string of bits is added to the processed value 412 after the rounding location and the added value is truncated. If the added random string of bits results in a larger digit at the rounding location, the added value is rounded up after the truncation. The post-processing circuit 428 is programmable to perform one of the rounding modes. The programming may be controlled by a command that is sent via NE control 418 from neural task manager 310. For example, a software engineer or a data scientist, in training a machine learning model, may select the rounding mode used. In some embodiments, standard rounding may be the default rounding mode and stochastic rounding may be selected. Further detail of the rounding operations of the post-processing circuit 428 is discussed in FIG. 6A through FIG. 9.

Computation core 416, the MAD circuits, accumulator 414, MAC 404, and post-processing circuit 428 are examples of different computation circuits in a neural engine 314.

NE control 418 controls operations of other components of neural engine 314 based on the operation modes and parameters of neural processor circuit 218. Depending on different modes of operation (e.g., group convolution mode or non-group convolution mode) or parameters (e.g., the number of input channels and the number of output channels), neural engine 314 may operate on different input data in different sequences, return different values from accumulator 414 to MAD circuits, and perform different types of post-processing operations at post-processing circuit 428. To configure components of neural engine 314 to operate in a desired manner, the NE control 418 sends task commands that may be included in information 419 to components of neural engine 314. NE control 418 may include a rasterizer 430 that tracks the current task or process loop being processed at neural engine 314.

Input data is typically split into smaller pieces of data for parallel processing at multiple neural engines 314 or neural engines 314 and planar engine 340. A set of data used for a convolution operation may be referred to as a convolution group, which can be split into multiple smaller units. The hierarchy of smaller units (segments) may be convolution groups, slices, tiles, work units, output channel groups, input channels (Cin), sub-Cins for input stride, etc. For example, a convolution group may be split into several slices; a slice may be split into several tiles; a tile may be split into several work units; and so forth. In the context of neural engine 314, a work unit may be a segment of the input data, such as data processed by planar engine 340 or data processed a prior cycle of neural engines 314 having a size that produces output values that fit into accumulator 414 of neural engine 314 during a single cycle of the computation core 416. In one case, the size of each work unit is 256 bytes. In such embodiments, for example, work units can be shaped to one of 16×16, 32×8, 64×4, 128×2 or 256×1 datasets. In the context of planar engine 340, a work unit may be (i) a segment of input data, (ii) data from neural engine 314 or (iii) data from a prior cycle of planar engine 340 that can be processed simultaneously at planar engine 340.

Rasterizer 430 may perform the operations associated with dividing the input data into smaller units (segments) and regulate the processing of the smaller units through the MACs 404 and accumulator 414. Rasterizer 430 keeps track of sizes and ranks of segments of the input/output data (e.g., groups, work units, input channels, output channels) and instructs the components of a neural processor circuit 218 for proper handling of the segments of the input data. For example, rasterizer 430 operates shifters 410 in input buffer circuits 402 to forward correct segments 408 of input data to MAC 404 and send the finished output data 328 to data buffer 334. Other components of neural processor circuit 218 (e.g., kernel DMA 324, data processor DMA 320, data buffer 334, planar engine 340) may also have their corresponding rasterizers to monitor the division of input data and the parallel computation of various segments of input data in different components.

Output circuit 424 receives processed values 417 from post-processing circuit 428 and interfaces with data processor circuit 318 to store processed values 417 in data processor circuit 318. For this purpose, output circuit 424 may send out as output data 328 in a sequence or a format that is different from the sequence or format in which the processed values 417 are processed in post-processing circuit 428.

The components in neural engine 314 may be configured during a configuration period by NE control 418 and neural task manager 310. For this purpose, neural task manager 310 sends configuration information to neural engine 314 during the configuration period. The configurable parameters and modes may include, but are not limited to, mapping between input data elements and kernel elements, the number of input channels, the number of output channels, performing of output strides, and enabling/selection of post-processing operations at post-processing circuit 428.

### Example Planar Engine Architecture

FIG. 5 is a block diagram of planar engine 340, according to one embodiment. Planar engine 340 is a circuit that is separated from neural engines 314 and can be programmed to perform in different modes of operations. For example, planar engine 340 may operate in a pooling mode that reduces the spatial size of data, in a reduction mode that reduces the rank of a tensor, in a gain-and-bias mode that provides a single-pass addition of bias and scaling by a scale factor, and in an elementwise mode that includes elementwise operations. For this purpose, planar engine 340 may include, among other components, a first format converter 502, a first filter 506 (also referred to herein as “multi-mode horizontal filter 506”), a line buffer 510, a second filter 514 (also referred to herein as “multi-mode vertical filter 514”), a post-processing circuit 518, a second format converter 522, and a planar engine (PE) control 530 (includes rasterizer 540). Planar engine 340 may include fewer components or further components not illustrated in FIG. 5. Each component in planar engine 340 may be embodied as a circuit or a circuit in combination with firmware or software.

Input data 342 of planar engine 340 may be fetched from one or more source datasets that are saved in data processor circuit 318. If a dataset to be processed by planar engine 340 is larger than a work unit of data that can be simultaneously processed by planar engine 340, such dataset may be segmented into multiple work units for reading as input data 342 to planar engine 340. Depending on the mode of planar engine 340, input data 342 may include data from one or more source datasets. The source dataset described herein refers to different data saved in neural processor circuit 218 for processing. Different components of neural processor circuit 218 may generate or transmit data that is saved in data processor circuit 318. For example, neural engines 314, planar engine 340 (which generated data in a previous operation cycle), and system memory 230 may generate or transmit different datasets that are saved in different memory locations of data processor circuit 318. Various source datasets may represent different tensors. In an operation cycle of planar engine 340, different source datasets may be fetched together as input data 342. For example, in an elementwise mode that involves the addition of two different tensors to derive a resultant tensor, the input data 342 may include data from two different source datasets, each providing a separate tensor. In other modes, a single source dataset may provide input data 342. For example, in a pooling mode, input data 342 may be fetched from a single source dataset.

First format converter 502 is a circuit that performs one or more format conversions on input data 342 in one format (e.g., a format used for storing in buffer 334) to another format for processing in subsequent components of planar engine 340. Such format conversions may include, among others, the following: applying a ReLU function to one or more values of input data 342, converting one or more values of input data 342 to their absolute values, transposing a tensor included in the sources, applying gain to one or more values of input data 342, biasing one or more values of input data 342, normalizing or de-normalizing one or more values of input data 342, converting floating-point numbers to signed or unsigned numbers (or vice versa), quantizing numbers, and changing the size of a tensor such as by broadcasting a value of a tensor in one or more dimensions to expand the rank of the tensor. The converted input data 342 and unconverted input data 342 to planar engine 340 are collectively referred to herein as “a version of the input data.”

First filter 506 is a circuit that performs a filtering operation in one direction. For this purpose, first filter 506 may include, among other components, adders, comparators, and multipliers. The filtering performed by first filter 506 may be, for example, averaging, choosing a maximum value or choosing a minimum value. When averaging, adders are used to sum the values of input data 342 and a weighting factor may be applied to the sum using a multiplier to obtain the average as the resultant values. When selecting maximum and minimum values, the comparators may be used in place of the adders and the multipliers to select the values.

Line buffer 510 is a memory circuit for storing the result such as one or more intermediate data obtained from first filter 506 or second filter 514. Line buffer 510 may store values of different lines and allows access from second filter 514 or other downstream components to fetch the intermediate data for further processing. In some modes, line buffer 510 is bypassed. Line buffer 510 may also include logic circuits to perform additional operations other than merely storing the intermediate data. For example, line buffer 510 includes adder circuits 512, which in combination with memory component, enables line buffer 510 to function as an accumulator that aggregates data generated from the results of first filter 506 or second filter 514 to separately store aggregated data of a dimension not to be reduced.

Similar to first filter 506, second filter 514 performs filtering operations but in a direction different from first filter 506. For this purpose, second filter 514 may include, among other components, adders, comparators, and multipliers. In the pooling mode, first filter 506 performs filtering operation in a first dimension, while second filter 514 performs filtering operation in a second dimension. In other modes, first filter 506 and second filter 514 may operate differently. In a reduction mode, for example, first filter 506 performs elementwise operations while second filter 514 functions as a reduction tree to aggregate values of data.

Post-processing circuit 518 is a circuit that performs further processing of values fetched from other upstream components. Post-processing circuit 518 may include specialized circuits that are efficient at performing certain types of mathematical computations that might be inefficient to perform using a general computation circuit. Operations performed by post-processing circuit 518 may include, among others, performing square root operations and inverse of values in a reduction mode. Post-processing circuit 518 may be bypassed in other operation modes.

In some embodiments, post-processing circuit 518 may also operate in different rounding modes similar to post-processing circuit 428. While the discussions of the rounding modes in FIG. 6A through FIG. 9 are mainly illustrated for post-processing circuit 428, same or similar operations may also be applied to post-processing circuit 518.

Second format converter 522 is a circuit that converts the results of preceding components in planar engine 340 from one format to another format for output data 344. Such format conversions may include, among others, the following: applying a ReLU function to the results, transposing a resultant tensor, normalizing or de-normalizing one or more values of the results, and other number format conversions. Output data 344 may be stored in data processor circuit 318 as the output of neural processor circuit 218 or as inputs to other components of neural processor circuit 218 (e.g., neural engine 314).

PE control 530 is a circuit that controls operations of other components in planar engine 340 based on the operation mode of planar engine 340. Depending on the different modes of operation, PE control 530 programs register associated with the different components in planar engine 340 so that the programmed components operate in a certain manner. The pipeline of components or connections between the components in planar engine 340 may also be reconfigured. In the pooling mode, for example, data processed at by first filter 506 may be stored in line buffer 510 and then be read by second filter 514 for further filtering. In the reduction mode, however, data is processed by first filter 506, then processed at second filter 514 and then accumulated in line buffer 510 that is programmed as an accumulator. In the elementwise mode, line buffer 510 may be bypassed.

PE control 530 also includes a rasterizer 540 that tracks the current task or process loop being processed at planar engine 340. Rasterizer 540 is a circuit that tracks units or segments of input data and/or loops for processing the input data in planar engine 340. Rasterizer 540 may control the fetch of segments to planar engine 340 in each operation cycle and may monitor the size and rank of each segment being processed by planar engine 340. For example, smaller segments of a dataset may be fetched as input data 342 in a raster order for processing at planar engine 340 until all segments of the source dataset are processed. In fetching the segments, rasterizer 540 monitors the coordinate of the segment in the dataset. The manner in which a dataset is segmented into input data 342 for processing at planar engine 340 may be different compared to how a dataset is segmented into input data 328 for processing at neural engines 314.

The dataset for processing at planar engine 340 may be larger than the capacity of planar engine 340 that can be processed in a single operation cycle. In such case, planar engine 340 fetches different segments of the dataset as input data 342 in multiple operating cycles. The fetched segment may partly overlap with a previously fetched segment and/or a next segment to be fetched. In one embodiment, the portion of overlapping data is fetched only once and reused to reduce the time and power consumption cost of planar engine 340 in fetching data.

### Example Modes of Rounding

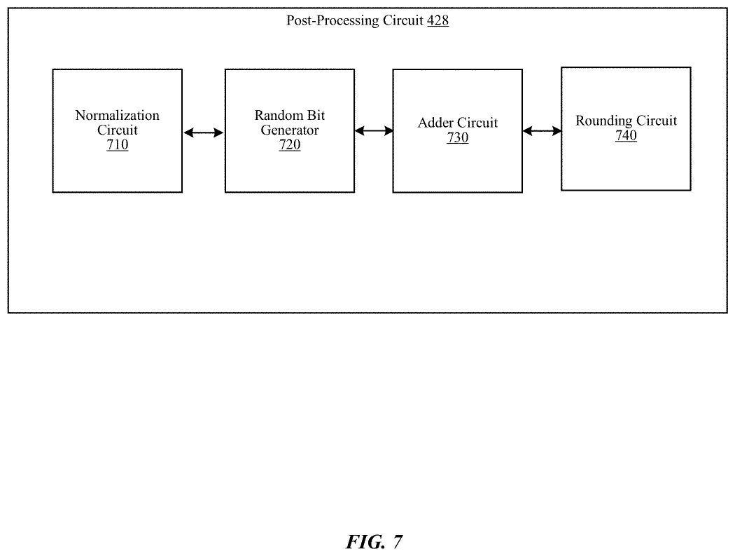

FIGS. 6A, 6B, and 6C are conceptual diagrams that illustrate different modes of rounding that may be operated by a post-processing circuit 428, according to an embodiment. FIG. 6A illustrates a standard rounding mode that uses a round half up rule. FIG. 6B illustrates a stochastic rounding mode for rounding an integer. FIG. 6C illustrates a stochastic rounding mode for rounding a floating-point number. Each of the modes can be performed by a programmable post-processing circuit 428 that will be further illustrated in FIG. 7.

Referring to FIG. 6A, a standard rounding mode is illustrated, according to an embodiment. An example processed value 412 is stored in an accumulator 414. Processed value 412 may be the resultant value of a computational task generated by a neural engine 314. The computation task may be related to a neural network such as a convolutional operation. For example, the convolutional operation can be convolution, tensor multiplication, dot product, or another suitable computation task. The example of processed value 412 is a floating-point 32 number with one bit of sign, eight bits of exponent and 23 bits of significand field. The post-processing circuit 428 first normalizes 612 the processed value 412 by identifying the leading one 602 in the significand field. For example, the leading one 602 is the leftmost “1” in the significand field. The rounding is to be performed at a rounding location 604 that is based on the setting of neural task manager 310. For example, the rounding location 604 is set at 11th bit after the leading one 602 in the processed value 412. The post-processing circuit 428 extracts the bits in the processed value 412 from the leading one 602 to the rounding location 604 plus an extra bit 606 right after the rounding location to generate a normalized value 612. The extra bit 606 after the rounding location 604 may be the sole bit that determines the rounding result in the standard rounding mode. To round 616 the processed value 412, a fixed single bit “1” 614 is added to the normalized value 612 to generate an added value 618. Carryover of the bits are calculated in an adder tree of the post-processing circuit 428. In turn, the post-processing circuit 428 re-normalizes 620 the added value 618 by truncating the bit after the rounding location 604. As such, the significand field of the floating-point processed value 412 is rounded to generate an output value 622.

Referring to FIG. 6B, a stochastic rounding mode for an integer is illustrated, according to an embodiment. An example processed value 412 is stored in an accumulator 414. Again, processed value 412 may be the resultant value of a computational task generated by a neural engine 314. Processed value 412 in this example is an integer. The integer (not shown in FIG. 6B) is converted to a floating-point number 630. In converting the integer to a floating-point value, the post-processing circuit 428 determines, based on the integer, a rounding location in the floating-point format. The rounding location in the floating-point format depends on the digit to which the integer is to be rounded. In turn, the post-processing circuit 428 converts the integer to a floating-point value. Unlike the standard rounding mode in which a fixed single bit is generated, a random string of bits 632 that is 32 bit long is generated. The random string of bits 632 may be generated by a random number generator. The random string of bits 632 is truncated at the rounding location to generate a truncated random string of bits 634. The truncated random string of bits 634 represents a random value that is in the size between zero and one in the rounding location. The post-processing circuit 428 adds the truncated random string of bits 634 to the floating-point value 630 to generate an added value 638. Post-processing circuit 428 truncates the added value 638 and normalizes the added value 638 to generate an output value 640 that is in the floating-point format. The rounded output value 640 may be converted back to integer format if needed.

Referring to FIG. 6C, a stochastic rounding mode for a floating-point number is illustrated, according to an embodiment. An example processed value 412 is stored in an accumulator 414. Again, processed value 412 may be the resultant value of a computational task generated by a neural engine 314. Processed value 412 in this example is in a floating-point format. Post-processing circuit 428 normalizes 650 processed value 412 based on the leading one 648 in processed value 412 to generate a normalized value 652. The normalization is based on the identification of the leading one 648 in the significand field of processed value 412. Post-processing circuit 428 identifies a rounding location 654 based on the rounding criteria provided by neural task manager 310. The rounding location 654 is relative to the leading one 648. In this example, the rounding location 654 is set at 11th bit after the leading one 648. Post-processing circuit 428 also generates a random string of bits 656. Post-processing circuit 428 adds 658 the random string of bits 656 to the normalized value 652. The random string of bits 656 is placed after the rounding location 654. This generates an added value 660. Post-processing circuit 428, in turn, rounds 662 the added value 660 by truncating the added value to generate the output value 668. The truncation occurs at the rounding location 654. If the random string of bits 656 generated is large enough, the addition will generate carry-over that moves the bit at the rounding location 654. As a result, processed value 412 is rounded up. If the random string of bits 656 is insufficiently large to move the bit at the rounding location, the bit at the rounding location 654 remains unchanged and the added value 660 is truncated. As a result, processed value 412 is rounded down. In some cases, the carry-over of in the addition step 658 is large enough that it will move the leading one. In such a case, post-processing circuit 428 re-normalizes 664 the output value 668. This type of stochastic rounding results in rounding that rounds up or down based on the probability defined by the rounding digit. For example, if the number is 0.3, since the random string of bits 656 generated will represent a number that is random between 0 and 1, the added value will be in the range of 0.3 and 1.3. After the truncation, 30% of the time the added value will be rounded up as 1 and 70% of the time the added value will be rounded down as 0.

### Example Post-Processing Circuit

FIG. 7 is a block diagram illustrating an example circuitry of post-processing circuit 428, according to an embodiment. The circuitry shown in FIG. 7 is merely one example configuration of post-processing circuit 428 that can operate in multiple modes of rounding. Other suitable structural arrangements and circuitry are also possible in various embodiments. Also, as discussed in FIG. 4, post-processing circuit 428 also performs tasks other than rounding. Those tasks may include applying activation functions, merging results, and local response normalization. In FIG. 7, only circuitry and components that are related to rounding are illustrated. Other components in the post-processing circuit 428 that are used to perform those tasks are not illustrated in FIG. 7.

In one embodiment, post-processing circuit 428 provides different modes of rounding. These modes may include standard rounding mode, integer stochastic rounding mode, and floating-point stochastic rounding mode. In one embodiment, post-processing circuit 428 may include a normalization circuit 710, a random bit generator 720, an adder circuit 730 and a rounding circuit 740. In various embodiments, post-processing circuit 428 may include additional, fewer, or different components.

Normalization circuit 710 converts a floating-point number to a string of bits that leads with one. Normalization circuit 710 identifies the leading one in the significand field of the floating-point number and truncates the preceding zeros in the significand field. Normalization circuit 710 may also truncate the sign bit and the exponent bits. The resultant normalized value states with one and may have a variable number of bits succeeding the leading one. Depending on the mode of rounding selected, normalization circuit 710 may also truncate certain bits after the rounding location. For example, in normalization step 610 of the standard rounding mode, only a certain number of bits are kept in the normalized value. In contrast, the entire remaining bits after the leading one are kept in the normalization step 650 in a stochastic rounding mode. The normalized value is aligned with a random string of bits after the rounding location to add the random string of bits to the normalized value.

Random bit generator 720 generates a random string of bits. Random bit generator 720 may use any suitable random bit generator, such as a linear-feedback shift register (LFSR). An LSFR includes one or more registers whose input bits are linear functions of the previous states. LFSR is a pseudo-random bit generator that has a very long cycle. LFSR can be skipped ahead to a specific start state based on an input seed so that a pseudo-random string of bits can be produced with a low chance of repetition given the long cycle of LFSR. Random bit generator 720 generates random strings of bits 634 and 656 in stochastic rounding modes. In one embodiment, each random bit generator 720 may take the form of LFSR113, which is a 32-bit random number generator. The generator is a combination of 4 sub-L SFR with a cycle of 2\hat{ }113-1.

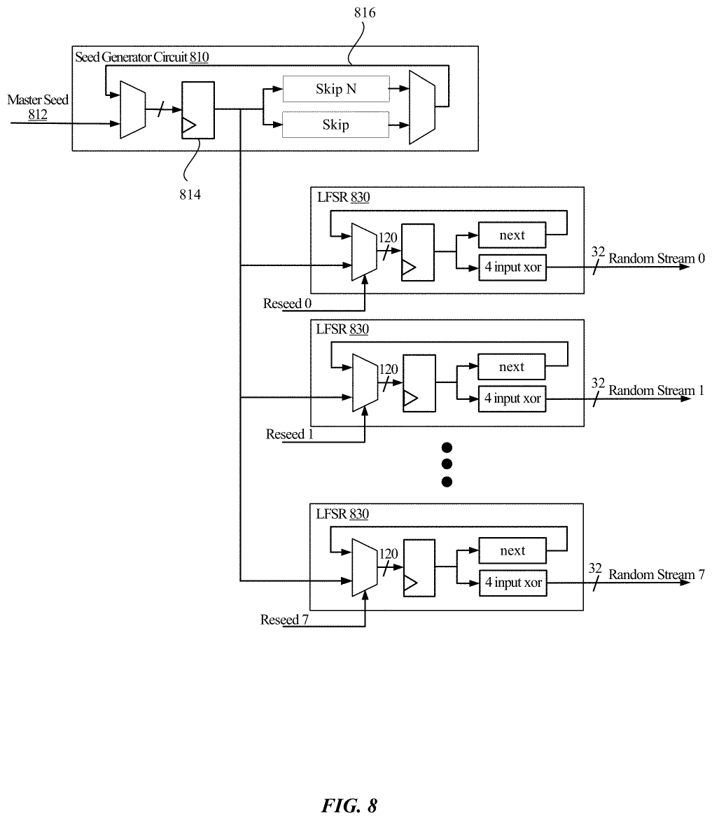

In some embodiments, a post-processing circuit 428 includes multiple random bit generators 720 that generate different strings of bits in parallel. In a computing cycle, a neural engine 314 may generate multiple processed values of various computational tasks. By using different start states, the LFSRs in random bit generator 720 generates different strings of bits that are used to round the processed values. In some embodiment, neural processor circuit 218 includes multiple neural engines 314, each including a post-processing circuit 428. The LFSRs among different neural engines 314 are seeded differently to generate different strings of bits. The detail of how a series of LFSRs are seeded differently is described in FIG. 8.

Adder circuit 730 aligns and adds a random string of bits that is generated by random bit generator 720 to a version of the processed value 412 to generate an added value. The version of the processed value 412 depends on the mode of rounding used. For example, in an integer stochastic rounding mode, the processed value 412 may be converted from an integer to a floating-point number. In floating-point stochastic rounding mode, the version of the processed value 412 may be a normalized value. Adder circuit 730 includes an adder tree that adds the random string of bits to the version of the processed value 412. The result of the addition is an added value that is passed to rounding circuit 740. In standard rounding mode, instead of a random string of bits, a single bit of 1 is added to the bit immediately succeeding to the rounding location. The addition may also be performed by adder circuit 730. In a stochastic rounding mode, a larger adder tree is activated to add the random string of bits to a version of processed value 412. In aligning the random string of bits, the random string of bits is put at a location that is right after the rounding location. Adder circuit 730 accounts for the carryover of the bits in the addition and updates the bits of the added value based on the carryover. In some cases, the added value is passed to normalization circuit 710 for re-normalization.

Rounding circuit 740 provides rounding of the processed value 412 by truncating the added value to generate an output value. The output value corresponds to the output of a computational task performed by neural engine 314. In some embodiments, rounding circuit 740 disregards the bits after the rounding value. Whether the processed value 412 is rounded up or down depends on the value of the random string bits and carryover resulting from the addition. For example, depending on the value of the random string of bits and the processed value 412, in some cases, a carryover may increase the value of the bit at the rounding location. After the added value is truncated, a rounding up of the processed value 412 occurs because the bit at the rounding location is increased. In other cases, any carryover to the right of the rounding location is not sufficiently large to affect the rounding location. As such, the bit at the rounding location is unchanged, thereby resulting in a round down after rounding circuit 740 truncates the added value at the rounding location. The rounded value may be put back to the significand field of the floating-point number or converted back to integer, depending on the format of the output.

### Example Random Bit Generator Circuit

FIG. 8 is an example circuit diagram of a random bit generator circuit 800 that includes multiple LFSRs to generate multiple different random strings of bits in parallel, according to an embodiment. In some embodiments, a neural processor circuit 218 includes multiple neural engines 314 and each neural engine 314 generates more than one processed value in each clock cycle. In some cases, each of the processed values needs to be rounded by a stochastic rounding mode. Circuit 800 is an example circuit that allows different random strings of bits to be generated so that the rounding of each processed value is performed independently without correlation with another processed value. As such, post-processing circuit 428 in each neural engine 314 may perform rounding operations of multiple processed values. For example, in one embodiment, a neural engine 314 may generate eight (8) independent streams of random numbers. A neural processor circuit 218 may include N (e.g., N=16) neural engines 314. In total, a large number of LSFRs, such as 128 LSFRs, are seeded by random bit generator circuit 800 and generate random numbers (random strings of bits) in parallel in each clock cycle. In some embodiments, each neural engine 314 includes a random bit generator circuit 800.

Random bit generator circuit 800 includes a seed generator circuit 810 and a plurality of LSFR circuits 830. An LSFR circuit 830 generates a random string of bits based on a seed value. The seed value represents a skip state of the LSFR. An LSFR circuit 830 is used in a post-processing circuit 428 of a neural engine 314. Seed generator circuit 810 may be connected to a plurality of neural engines 314 and generates seeds for the LSFR circuits 830 in those neural engines 314 based on a master seed 812. Each LSFR circuit 830 is seeded at the start of a neural task that is specified by neural task manager 310. Using seed generator circuit 810, the seeds for different LSFR circuits 830 within a neural engine 314 or among different neural engines 314 are different even though the seeds may be generated using the same master seed 812. As such, a different skip state is used for each LSFR circuit 830 to generate random numbers to avoid one or more LSFR circuits 830 generating the same series of random numbers.

Seed generator circuit 810 generates multiple seeds for different LSFR circuits 830 based on a master seed 812. Seed generator circuit 810 may receive the master seed 812 from neural task manager 310. Seed generator circuit 810 includes an internal loop that repetitively generates different seed values. Seeding can take multiple clock cycles to complete. In one embodiment, seed generator circuit 810 includes a latch 814 and an internal loop 816. In a given task, a master seed 812 is loaded to seed generator circuit 810. For a given bit of the master seed 812, if latch 814 has the state of “0,” the seed is skipped once. If latch 814 has the state of “1,” the master seed 812 is skipped N times. Each LSFR circuit 830 is assigned to a unique identifier. Each LSFR circuit 830 may be seeded by starting with the master seed 812. The generator may be advanced by a specific number multiplied by the identifier value. By repeating the latching and the internal loop 816, seeds are skipped from the master seed 812 by different extents for seeds that are used in a neural engine 314 and for seeds in different neural engines 314. After completion of the seeding cycles, different seed values are sent to different LSFR circuits 830. Each LSFR circuit 830 is skipped forward based on an individual seed, which may correspond to a different value derived from the master seed 812. For example, a first LFSR circuit 830 of the plurality of LFSR circuits 830 is skipped forward a first number of times to generate a first string of bits. A second LFSR circuit 830 of the plurality of LFSR circuits 830 is skipped forward a second number of times to generate a second string of bits different from the first string of bits because the seedings are different.

The plurality of LFSR circuits 830 may operate in parallel to generate different random strings of bits in parallel. Each LSFR circuit 830 may include sub-LSFRs to increase the complexity and cycle of the overall LSFR circuit 830. For example, in the example shown in FIG. 8, a type of LSFR called LSFR113 is used. Other suitable types of LSFR may also be used. The eight (or another suitable number) LSFR circuits 830 illustrated in FIG. 8 may be included in a post-processing circuit 428 of a neural engine 314. In some embodiments, N sets of eight LSFR circuits 830 may be connected to seed generator circuit 810. Each set may be included in a neural engine 314.

In some embodiments, master seeds 812 for various tasks are stored so that operations related to a machine learning model can be repeated for verification purposes. For example, a master seed 812 for a particular task is saved in neural task manager 310. If an identical task is repeated, the master seed 812 may be retrieved to generate various seeds for the different LSFR circuits 830 to repeat the rounding purposes. In some embodiments, a neural network may include a plurality of layers. Neural task manager 310 generates a different master seed 812 for each layer and stores the master seeds 812 for verification purposes.

### Example Process for Performing Stochastic Rounding

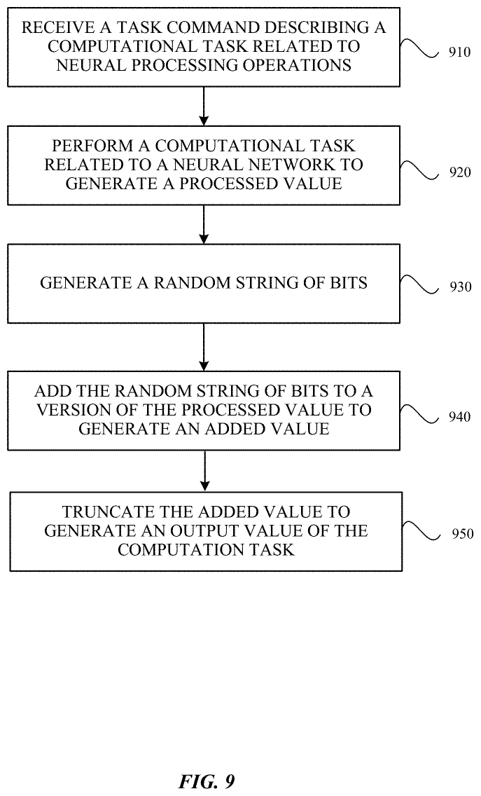

FIG. 9 is a flowchart depicting an example process for performing stochastic rounding in a neural processor, according to an embodiment. The neural processing operations may be part of a machine learning model process, whether operations occur in the training or runtime of the machine learning model. The neural processing operations may be performed by neural processor circuit 218 that is effective at performing various machine learning model operations and computations. In some embodiments, the stochastic rounding process is performed by a neural engine 314.

In one embodiment, a neural engine 314 receives 910 a task command describing a computational task related to neural processing operations. For example, the computational task may be a convolutional operation. The task command may be sent from neural task manager 310. The task command may specify the type of computational task and also the selected rounding mode. The rounding modes available may include standard rounding, integer stochastic rounding, or floating-point stochastic rounding. Neural task manager 310, in transmitting one or more task commands to various neural engines 314, may also generate a master seed for generating random numbers. The master seed may be specific to a particular task to be performed by a neural engine 314 or may be shared by multiple tasks that are performed in parallel by different neural engines 314 during the same period of clock cycles. The master seed may be saved by neural task manager 310 and can be retrieved for verification.

In one embodiment, neural engine 314 performs 920 a computational task related to a neural network to generate a processed value 412. For example, the computational task may be a convolutional operation. The computational task may be specified by a task command and may be a computation such as convolution, matrix multiplication, dot products, etc. The computational task may correspond to operations in a layer of the neural network. In some embodiments, a master seed for generating random numbers is used for the same layer of the neural network while other master seeds are generated for other layers. The computation task may be performed by MAC 404 and processed value 412 may be initially saved in accumulator 414. Processed value 412 may be an integer or a floating-point number, depending on the type of task and selection made by neural task manager 310.

Based on the task command that may include a selection of the rounding mode, a stochastic rounding mode may be selected. A post-processing circuit 428 in neural engine 314 performs the rounding of the processed value 412 stochastically. In one embodiment, post-processing circuit 428 generates 930 a random string of bits. For example, post-processing circuit 428 may include a random bit generator that generates the random string of bits. The random bit generator may take the form of an LSFR circuit that generates a random number based on a seed value. The seed may be generated by a seed generator circuit 810 using a master seed in preparation for the task. The random string of bits generated includes more than one bit and, in some embodiments, may be 32 bits long. Further detail in how a random number or multiple random numbers are generated is discussed in FIG. 8.

In one embodiment, post-processing circuit 428 adds 940 the random string of bits to a version of the processed value 412 to generate an added value. For example, post-processing circuit 428 includes an adder circuit 730 that is used to add the random string of bits at a location immediately succeeding the rounding location. The version of the processed value 412 may be a floating-point value converted from an integer, a normalized value that starts with the leading one in a floating-point number, or another suitable version. The addition accounts for any carry-over that may affect the bit at the rounding location to determine whether the bit is increased.

In one embodiment, post-processing circuit 428 uses a rounding circuit 740 to truncate 950 the added value to generate an output value of the computation task. The bit at the rounding location may be increased due to the addition of the random string of bits. In such a case, the processed value 412 is rounded up in the stochastic rounding mode. In other cases, the random string of bits may be insufficient to move the bit at the rounding location. As such, after the truncation, the processed value 412 is rounded down in the rounding operation. The rounded value may be renormalized or converted to the desired form, such as integer or floating-point number, as the output of neural engine 314.

While particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

What is claimed is:

1. A neural processor circuit comprising:
a neural engine configured to perform a convolutional operation related to a neural network to generate a processed value; and
a post-processing circuit coupled to neural engine, the post-processing circuit configured to round the processed value stochastically, the post-processing circuit comprising:
a random bit generator configured to generate a random string of bits;
an adder circuit configured to add the random string of bits to a version of the processed value to generate an added value; and
a rounding circuit configured to truncate the added value to generate an output value of the convolutional operation.

2. The neural processor circuit of claim 1, wherein the post-processing circuit is configured to provide multiple modes of rounding and the multiple modes include a standard rounding mode, an integer stochastic rounding mode and a floating-point stochastic rounding mode.

3. The neural processor circuit of claim 1, wherein the processed value is in a floating-point format, and rounding of the processed value comprises:
normalizing the processed value based on a leading one in the processed value to generate a normalized value;
adding, after a rounding location, the random string of bits to the normalized value to generate the added value, wherein the rounding location is relative to the leading one; and
truncating the added value to generate the output value.

4. The neural processor circuit of claim 1, wherein the processed value is an integer, and rounding of the processed value comprises:
determining, based on the integer, a rounding location in a floating-point format;
converting the integer to a floating-point value;
adding, after the rounding location, the random string of bits to the floating-point value to generate the added value;
truncating the added value; and
normalizing the added value to generate the output value.

5. The neural processor circuit of claim 1, wherein the random bit generator comprises a linear-feedback shift register (LFSR) having one or more registers whose input bits are linear functions of previous states.

6. The neural processor circuit of claim 1, wherein the post-processing circuit is configured to support rounding operations of a plurality of processed values, the plurality of processed values comprising the processed value and other processed values generated by the neural engine.

7. The neural processor circuit of claim 1, wherein the random bit generator is coupled to a master seed generator that generates a master seed, and the random bit generator is configured to generate the random string of bits derived from the master seed.

8. The neural processor circuit of claim 7, wherein the random bit generator comprises a linear-feedback shift register (LFSR) and the LFSR is skipped forward based on a value derived from the master seed.

9. The neural processor circuit of claim 7, wherein the neural network includes a plurality of layers and the post-processing circuit generates a different master seed for each layer.

10. The neural processor circuit of claim 7, wherein the master seed is stored for verification.

11. The neural processor circuit of claim 1, wherein the random bit generator includes a plurality of linear-feedback shift registers (LFSRs) for generating multiple strings of bits in parallel.

12. The neural processor circuit of claim 11, wherein at least a first LFSR of the plurality of LFSRs is skipped forward a first number of times to generate a first string of bits and a second LFSR of the plurality of LFSRs is skipped forward a second number of times to generate a second string of bits different from the first string of bits.

13. A method comprising:
performing, at a neural engine, a convolutional operation related to a neural network to generate a processed value;
generating a random string of bits at a random bit generator;
adding the random string of bits to a version of the processed value to generate an added value; and
truncating the added value to generate an output value of the convolutional operation, the output value being a stochastically rounded value of the processed value.

14. The method of claim 13, wherein the processed value is in a floating-point format, and rounding of the processed value comprises:
normalize the processed value based on a leading one in the processed value to generate a normalized value;
add, after a rounding location, the random string of bits to the normalized value to generate the added value, wherein the rounding location is relative to the leading one; and
truncate the added value to generate the output value.

15. The method of claim 13, wherein the processed value is an integer, and rounding of the processed value comprises:
determining, based on the integer, a rounding location in a floating-point format;
converting the integer to a floating-point value;
adding, after the rounding location, the random string of bits to the floating-point value to generate the added value;
truncating the added value; and
normalizing the added value to generate the output value.

16. The method of claim 13, wherein the random bit generator comprises a linear-feedback shift register (LFSR) having one or more registers whose input bits are linear functions of previous states.

17. The method of claim 13, further comprising:
generating a master seed;
deriving a seed for the random bit generator from the master seed; and
generating the random string of bits using the seed.

18. The method of claim 17, wherein the neural network includes a plurality of layers and a different master seed is generated for each layer.

19. A computing device, comprising:
a memory configured to store a neural network; and
a neural processor circuit coupled to the memory, the neural processor circuit configured to:
perform, at a neural engine, a convolutional operation related to the neural network to generate a processed value;
generate a random string of bits at a random bit generator;
add the random string of bits to a version of the processed value to generate an added value; and
truncate the added value to generate an output value of the convolutional operation, the output value being a stochastically rounded value of the processed value.

20. The computing device of claim 19, wherein the random bit generator comprises a linear-feedback shift register (LFSR).
